(19) United States
(12) Patent Application Publication
(10) Pub. No.: US 2023/0359414 A1
(43) Pub. Date: Nov. 9, 2023

(54) CONTEXT-AWARE PRINTER SELECTION

(71) Applicant: International Business Machines Corporation, Armonk, NY (US)

(72) Inventors: PERINKULAM I GANESH, Round Rock, TX (US); Esdras E. Cruz-Aguilar, Round Rock, TX (US); Michael Burton, Austin, TX (US); Luis Osvaldo Pizana, Austin, TX (US)

(21) Appl. No.: 17/662,146

(22) Filed: May 5, 2022

(51) Int. Cl. G06F 3/12

(52) U.S. Cl. CPC G06F 3/1238; G06F 3/1204; G06F 3/1222

(57) ABSTRACT

A method, system, and computer program product are disclosed. The method includes receiving a file to be printed from a device and, in response to the receiving, managing printer access for the device. Managing the printer access includes obtaining printer data from printers accessible to the device, obtaining correlation data corresponding to a printer access filter enabled on the device, filtering the printers based on the correlation data and the printer data, and inhibiting access to at least one of the printers based on the filtering.

### BACKGROUND

The present disclosure relates to network printing, and more specifically, to management of printer access and selection.

Network printing can allow users to print files from a user device to one or more printers connected to the same network. There can be more than one physical printer available via the network. When printing a document, a user can select which available printer to use from a list of printers displayed on the user device.

### SUMMARY

Various embodiments are directed to a method, which includes receiving a file to be printed from a device and, in response to the receiving, managing printer access for the device. Managing the printer access includes obtaining printer data from printers accessible to the device and obtaining correlation data corresponding to a printer access filter enabled on the device. Managing the printer access also includes filtering the printers based on the correlation data and the printer data and inhibiting access to at least one of the printers based on the filtering.

Further embodiments are directed to a system, which includes a memory and a processor communicatively coupled to the memory, wherein the processor is configured to perform the method. Additional embodiments are directed to a computer program product, which includes a computer readable storage medium having program instructions embodied therewith, the program instructions executable by a processor to cause a device to perform the method.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of typical embodiments and do not limit the disclosure.

FIG. 1 is a block diagram illustrating a computing environment having a printer access manager, according to some embodiments of the present disclosure.

FIG. 2 is a flowchart illustrating an example process of managing printer access, according to some embodiments of the present disclosure.

FIG. 3A is a schematic diagram illustrating graphical user interface (GUI) elements for configuring printer access filters, according to some embodiments of the present disclosure.

FIG. 3B is a schematic diagram illustrating example GUI elements for displaying printing options, according to some embodiments of the present disclosure.

FIG. 4 is a block diagram illustrating a computer system, according to some embodiments of the present disclosure.

FIG. 5 is a block diagram illustrating a cloud computing environment, according to some embodiments of the present disclosure.

FIG. 6 is a block diagram illustrating a set of functional abstraction model layers provided by the cloud computing environment, according to some embodiments of the present disclosure.

### DETAILED DESCRIPTION

Aspects of the present disclosure relate generally to network printing and, more specifically, to managing printer access. While the present disclosure is not necessarily limited to such applications, various aspects of the disclosure may be appreciated through a discussion of various examples using this context.

Network printing can allow users to print files (e.g., documents and images) from a user device (e.g., laptop, desktop, tablet, mobile phone) connected to a network to one or more printers connected to the network. In some instances, such a user can select, among any of the one or more printers, a printer to receive a file to be printed (i.e., a destination printer). While the ability of the user to select among any of such printers can provide user convenience, in some instances, it can lead to unintended results. For example, in some instances, a user can inadvertently select a destination printer that is remotely located. For example, the user, while working in a home office, can inadvertently select a destination printer that is located in the user's business office. In this example, a file printed at the destination printer can be lost or misplaced before the user can retrieve it. In a similar example, such a user, while working in the user's business office, can inadvertently select as a destination printer a shared common area printer, rather than the user's personal office printer, to print confidential employee documents. The error could result in the documents being compromised and could jeopardize employee privacy. While some printers can include enhanced security features, such as badge readers and/or passwords, to prevent erroneous printing at a destination printer, employing such features can be cumbersome and/or economically impractical for some entities.

To address these and other challenges, embodiments of the present disclosure include a printer access manager. In some embodiments, the printer access manager can inhibit access to one or more printers based on predetermined criteria that can be selected by a user. For example, in some embodiments, in response to a location of a user device matching a predetermined location, the printer access manager can restrict a display of a user device such that one or more printers available for selection as a destination printer are not displayed. In some embodiments, in response to an opened file having one or more characteristics that match one or more predetermined characteristics, the printer access manager can restrict a display of a user device such that a visibility of one or more printers available for selection as a destination printer is obstructed. Inhibiting printer access can also include blocking access to one or more of the printers by, for example, preventing a document from being printed automatically and/or without a manual override. By inhibiting access to printers based on user-selected criteria, embodiments of the present disclosure can permit a user to tailor the printer access manager according to the user's objectives. Additionally, embodiments of the present disclosure can facilitate secure, efficient printing by a plurality of printer types, including printers that lack security features such as badge-reading capability and/or password-protected operation.

It is to be understood that the aforementioned advantages are example advantages and should not be construed as limiting. Embodiments of the present disclosure can contain all, some, or none of the aforementioned advantages while remaining within the spirit and scope of the present disclosure.

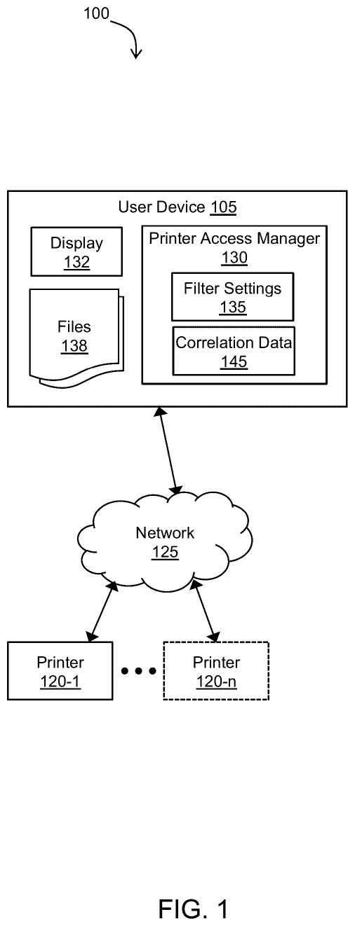

Turning now to the figures, FIG. 1 is a schematic diagram illustrating a printer access environment 100, according to some embodiments of the present disclosure. Environment 100 can include a user device 105 (also referred to herein as a “personal device”) and one or more printers 120-1-120-n (collectively, printers 120). The printers 120 and user device 105 can exchange data with one another through a network 125. In some embodiments, the network 125 is a wide area network (WAN), a local area network (LAN), the internet, or an intranet. The set of printers 120 can include one or more printers. For example, in some embodiments, the set of printers 120 can include one printer (120-1) to n printers (120-n), where n is an integer greater than zero. For example, n=2 in embodiments in which the set of printers 120 includes two printers (a first printer 120-1, as shown in FIG. 1, and a second printer 120-2) and so on.

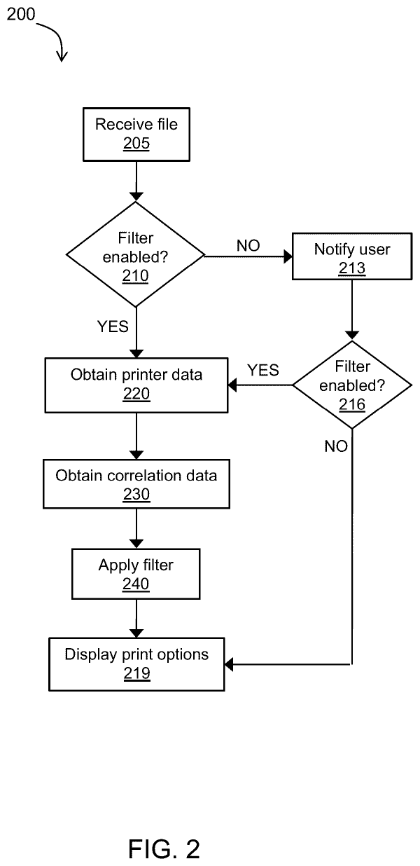

In some embodiments, the set of printers 120 can include one or more devices configured to receive and print files, such as documents and images, to physical media such as paper. In some embodiments, at least one of the printers may be configured to send digital copies of files to another device and/or user. The set of printers 120 can be accessible by at least one user device 105 through at least one network 125. Accordingly, the set of printers 120 can be configured to print one or more files received through at least one network from at least one user device 105. In some embodiments, a printer can be accessible to the user device 105 based, at least in part, on the printer and the user device 105 sharing a location (e.g., both the user device 105 and the printer being located in the same facility, such as an office building). In some embodiments, a printer can be accessible to a user device 105 from a plurality of locations, such as locations where the user device can access a particular network (e.g., a virtual private network (VPN)) to which the printer is connected. In some embodiments, the set of printers 120 can store and transmit printer data to the printer access manager 130. This is discussed in greater detail with respect to FIG. 2.

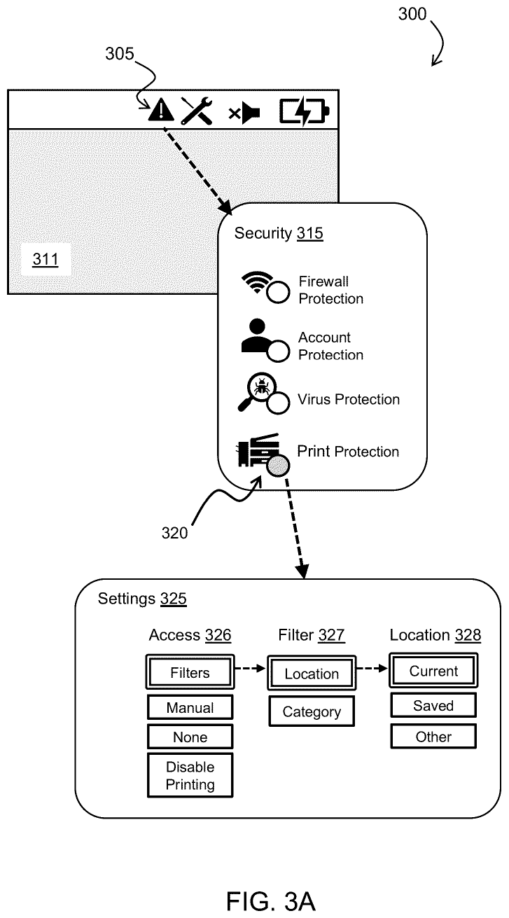

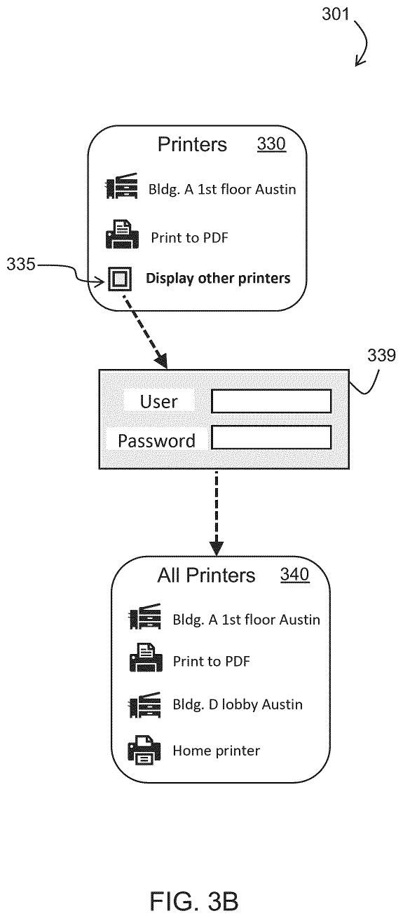

The user device 105 can include a device such as a notebook computer, tablet, desktop computer, mobile phone (e.g., a “smartphone”), tablet, wearable technology (e.g., a “smartwatch”), and the like. While not shown in FIG. 1, there can be more than one user device 105 associated with the printer access manager 130 in some embodiments. The user device 105 can include a display 132 configured to present a graphical user interface (GUI) that permits a user to view, select, and/or input data, such as filter settings 135, files 138, visual representations corresponding to one or more printers 120 (see, e.g., FIGS. 3A and 3B), etc. In some embodiments, the files 138 can include items such as text documents and/or images.

The printer access manager 130 can be included in software installed on the user device 105. The printer access manager 130 can include filter settings 135 and correlation data 145. The filter settings 135 can include at least one default and/or user-configured filter for selecting one or more of the printers 120. For example, there can be a location-based filter, a user device-based filter, a file-based filter, etc. The filters available in the filter settings 135 can have corresponding correlation data 145. In some embodiments, correlation data 145 can be stored in a list, database, matrix, table, etc. (see, e.g., Tables 1 and 2). The correlation data 145 can include at least one set of data related to the user device 105, files 138, and/or printers 120. The type of correlation data 145 used to filter printer access can depend upon which printer access filter is enabled. This is discussed in greater detail with respect to FIG. 2.

Correlation data 145 can include a location of the user device 105 (e.g., GPS coordinates), user identity (e.g., based on login information), device operating system, security settings, enterprise policies, etc. In some embodiments, user device correlation data 145 can include a time (e.g., a time of day and/or a date) corresponding to a location of a user device 105. In this way, the printer access manager 130 can recognize changes in the location of the user device 105 with respect to time. Correlation data 145 can also include information that associates a printer 120 with a location and/or file(s) 138.

Further, correlation data 145 can include information regarding one or more of the files 138 (“file data”). In some embodiments, file data can be stored in a file's metadata. Examples of file data can include category designations. Such a category designation can be selected by an entity, such as a user or an administrator, and describe a general classification of the content of the file. File data can also include content information extracted from the document to be printed. For example, keywords and/or other extracted information (e.g., image content, formatting, signatures, etc.) may indicate that a file corresponds to a given topic (e.g., financial records, family photos, etc.), location (e.g., home, office, etc.), and/or security category (e.g., confidential, non-confidential, personal, etc.).

Further, the correlation data 145 may be transmitted from such a user device 105 or computing device to the printer access manager through the network 125. The printer access manager 130 can utilize correlation data 145 to individually manage access by one or more user devices to respective sets of printers, as discussed with respect to method 200.

In some embodiments, correlation data 145 can be stored on the user device 105 or another computing device (not shown). For example, in some embodiments, the user device 105 can be a laptop computer, and the correlation data 145 can be stored in the memory of the laptop computer. In another example, in some embodiments, the computing device can be a server, and the correlation data can be stored in the memory of the server for use with a specific user device 105. In some embodiments, correlation data can be stored in metadata of a file. For example, in some embodiments, a file such as “Annual Reports.docx” can have metadata that includes file correlation data 145 for a first user device 105. In this example, the printer access manager 130 can obtain the file correlation data 145 from the metadata and manage the first user device's 105 access to one or more printers 120 as discussed with respect to process 200 (see below).

Correlation data and/or filter settings can be managed and maintained on individual devices, and the printer access manager 130 can be independent of printer architecture, location, and file type. In some embodiments, the user device 105 does not share correlation data 145 with other devices. For example, a user may transfer files 138 (e.g., an email attachment) from the user device 105 to another computing device without transferring associated filter settings 135 and/or correlation data 145 from the printer access manager 130. Printer preferences configured on the other computing device can then be used to print the received file. In another example, a file attached to an email may be opened on the user device 105. The printer access manager 130 can override default settings associated with the printers 120, file type of the attachment, and/or filters applied by the sender of the email in order to implement the preferred filter settings 135. In some embodiments, the printer access manager 130 can be extended to at least one VPN, and the filter settings 135 can be applied recursively to each VPN.

FIG. 2 is a flowchart illustrating a process 200 of performing printer access management, according to some embodiments of the present disclosure. Process 200 can be performed by components of environment 100 and, for illustrative purposes, is discussed with reference to FIG. 1.

A file can be received. This is illustrated at operation 205. For example, a document from files 138 can be opened or selected on user device 105. The file can be any document (e.g., text and/or image document) that may be intended for printing. Operation 205 may include user-selection of an option such as “print document”, “print setup”, “open printer access manager”, etc. The printer access manager 130 can then receive the selected file.

It can then be determined whether a printer access filter has been enabled on the user device 105. This is illustrated at operation 210. For example, the printer access filter can be a location-based filter, a file-based filter, a device-based filter, etc. selected from the filter settings 135. In instances where more than one printer access filter is enabled, a preferred filter can optionally be selected. For example, the user can be prompted to manually select a filter from the filter settings 135. The enabled filter can also be determined based on file data local to the user device 105 (e.g., saved in metadata, a local database, etc.). For example, a user can manually select a filter setting for a document when creating or saving the document.

If printer access filters have not been enabled, a notification can be generated. This is illustrated at operation 213. For example, the absence of an enabled filter can be conveyed to the user via display 132 with a pop-up message, a menu showing printer access filter options, or another visual indicator such as an icon, a secondary icon (e.g., an overlay icon), a color, etc. For example, if the printer access manager 130 detects it has access to network printers, a security icon may provide an indicator that user action is needed in order to enable or configure security settings. An example such as this is illustrated in FIG. 3A. Options for user actions such as enabling/selecting a printer access filter, manually overriding printer access filters, dismissing the notification, disabling all filters, etc. may be provided. In some embodiments, there may be an option to enable/disable filters using, for example, a checkbox, toggle, or other element. In some embodiments, an indicator that no filters are enabled can be displayed prior to a file being received at operation 205.

FIG. 3A is a schematic diagram illustrating example graphical user interface (GUI) elements 300 for printer access filter selection, according to some embodiments of the present disclosure. The GUI elements 300 may be implemented via the display 132 of the user device 105 illustrated in FIG. 1. In this example, a user can select a security icon 305 in a desktop environment 311. In some embodiments, at least one of GUI elements 300 can be provided when a document is saved or selected for printing.

In response to user-selection of the security icon 305, a security window 315 can appear. The security window 315 may also appear in response to receiving a document to be printed (e.g., at operation 205, illustrated in FIG. 2). The security window 315 can display icons representing access (e.g., shortcuts or links to settings/preferences) to “firewall protection”, “account protection”, “virus protection”, and “print protection”. The icons on security window 315 are overlaid with secondary icons (circles) indicating security status based on color. In this example, the status indicator 320 over the “print protection” icon can be a different color than the other indicators, indicating that filter settings are not enabled/configured.

Selection of the icon/status indicator 320 can cause a printer access filter settings window 325 to open in the desktop environment 311 and provide a list of access options 326. While the security window 315 and the settings window 325 are shown outside of the desktop environment 311 in FIG. 3A, the windows 315 and 325 can be displayed within the desktop environment 311 or any appropriate user interface configuration known in the art.

The illustrated access options 326 include “filters” (e.g., enabling or selecting filters), “manual” (e.g., manually overriding existing or default filters), “none” (e.g., disabling all filters), and “disable printing” (e.g., inhibiting all printer access and/or allowing only printing to pdf). User-selected options from the settings window 325 are indicated by a double outline. In this example, the user selects “filters” from the list of access options 326. In response to the selection of “filters” from the access options 326, a list of filter options 327 is provided. The illustrated filter options 327 include location-based filters and category-based filters. In other embodiments, there can be additional and/or alternative filter options (e.g., more specific categories and/or locations). Types of access filters are discussed in greater detail with respect to FIGS. 1 and 2. In this example, the user selects a location-based filter (“location”).

In response, a list of location options 328 including “current” (e.g., based on GPS coordinates of the user's personal device), “saved” (e.g., locations of previously used printers, user-input locations such as “home” and “office”, etc.), and “other” (e.g., a new address, network, GPS coordinates, etc. entered by the user or automatically identified upon selection of “other”) is provided. In the example illustrated in FIG. 3A, the user selects “current” in order to view a window (not shown) showing printers available in the vicinity of their personal device.

Referring again to FIG. 2, it can be determined whether the user selected a printer access filter to be enabled in response to the notification. This is illustrated at operation 216. If the user ignored or dismissed the notification generated at operation 213 (e.g., by ignoring the security icon 305 or selecting “none” from the settings window 325 illustrated in FIG. 3A), process 200 can proceed to operation 219, whereupon all available and/or connected printers can be displayed. If no printers are available (e.g., none are connected to the network 125 or “disable printing” was selected from the settings window 325), the display options generated at operation 219 can indicate that printing is unavailable.

However, if it is determined at operation 210 or 216 that a printer access filter has been enabled, process 200 can proceed to operation 220. At operation 220, printer data can be obtained from available printers. For example, while not shown in FIG. 1, printer data can be obtained from printer(s) 120 sharing a network 125 with the user device 105. In some embodiments, the printer access manager 130 can obtain printer data from a resource such as the user's personal device 105, the printers 120, or another computing device (not shown). In some embodiments, the printer data can be stored in a location such as a database of such a user device, printer, and/or computing device.

Printer data can include information such as location information and/or identifying information for one or more printers. Such information can distinguish one printer from one or more other printers. Location data can specify a printer's location. For example, location data may include an address where a printer is located, coordinates of a printer's location (e.g., global positioning system (GPS) coordinates), identifying information for a facility (e.g., “Austin Campus, Bldg. A”) or an area of a facility (e.g., “Conference Room B”) where a printer is located, etc.

Identifying information can further distinguish one printer from other printers. For example, in some embodiments, printer data can include information such as a printer name (e.g., “Printer C”), a printer identification code (e.g., serial number, model number, etc.), and/or a visual representation of a printer (e.g., a digital image, icon, name and/or symbol displayable to represent a printer on a graphical user interface). In some embodiments, printer data can include both location data and identification data (e.g., “Bldg. D—Dallas—Lobby Printer E”).

Correlation data corresponding to the enabled printer access filter is obtained. This is illustrated at operation 230. In some embodiments, the correlation data is obtained from the correlation data 145 stored on the user device 105 and can include file data, location data, user device data, etc. This is discussed in greater detail with respect to FIG. 1.

Correlation data 145 can include information that, for a specific user device 105, associates a printer 120 with a location and/or file(s). Based on the printer information obtained at operation 220 and the correlation data obtained at operation 230, the filter(s) can be applied. This is illustrated at operation 240. The associations between printers and locations and/or files can be established by, for example, pairing printer data with location data in a database, matrix, or table, such as Table 1.

TABLE 1

Mobile phone: location correlation data

| | Printer | Office Location |
|---|---|---|
| 1 | Bldg. 3 - Lobby | Dallas |
| 2 | Office Desk Printer | San Francisco |
| 3 | Floor 2 Conf. Room Printer | Austin |
| 4 | Desk Printer | Home |

Table 1 shows location correlation data 145 for a specific user device 105 (“mobile phone”). Table 1 identifies a set of printers 120 and a set of respective office locations. Row 1 of Table 1 shows a printer identified as “Bldg. 3—Lobby” corresponding to a geographical location “Dallas.” In some embodiments, the printer access manager 130 may inhibit the user device's 105 access to a set of printers 120 except the “Bldg. 3—Lobby” printer in response to determining that the user device 105 is in Dallas. Row 2 shows a printer identified as “Office Desk Printer” having a corresponding office location “San Francisco.” In some embodiments, the printer access manager can inhibit access to a set of printers except “Office Desk Printer” when the user device is determined to be in San Francisco. Row 3 shows a printer identified as “Floor 2 Conf. Room Printer” having a corresponding office location “Austin.” Row 4 shows a printer identified as “Desk Printer” having a corresponding office location “Home.” In this example, “Home” can represent a user's residential address.

In some embodiments, correlation data can include file correlation data that relates a file and/or a category of files with a specific printer. For example, in some embodiments, file correlation data can associate a given file with a specific printer. In some embodiments, file correlation data can associate a category of files, such as documents regarding a given topic (e.g., annual budget plans) or meeting another criterion (e.g., confidentiality level), with a specific printer. As discussed above, printer/file category correlation data can be configured automatically or selected by a user. The correlation data can be established by pairing printer data with file data in a database, matrix, or table, such as Table 2 below.

TABLE 2

Laptop computer: file correlation data

| | Printer | File(s) |
|---|---|---|
| 1 | Desk Printer A | Department Evals.doc |
| 2 | Bldg. 44 - Finance Printer B | Category: Tax |
| 3 | Printer 3-C | picnic.jpg |
| 4 | Bldg. 44 - Finance Printer D | Annual Budget.xlsx |

Table 2 shows file correlation data for a another user device 105 (“laptop computer”). Table 2 identifies a set of printers and a set of respective files. For example, row 1 shows a file “Department Evals.doc” having a corresponding printer “Desk Printer A.” As discussed in further detail below, in some embodiments, the printer access manager can inhibit access to a set of printers except “Desk Printer A” for printing “Department Evals.doc” from the user device. The printer access manager can perform such inhibiting in response to determining that “Department Evals.doc” is opened on the user device. Row 2 shows a set of files having a category designation “Tax” having a corresponding printer “Bldg. 44—Finance Printer B.” As discussed in further detail below, in some embodiments, the printer access manager can inhibit access to a set of printers except “Bldg. 44—Finance Printer B” for printing files having the category designation “Tax” from the user device. The printer access manager can perform such inhibiting in response to determining that a file having the category designation “Tax” is opened on the user device. Row 3 shows a file “Org Chart.jpg” having a corresponding printer “Printer 3-C.” Row 4 shows a file “Annual Budget.xlsx” having a corresponding printer “Bldg. 44—Finance Printer D.”

In some embodiments, filter settings 135 can include a user-selected priority between location correlation data and file correlation data. For example, in some embodiments, a user can elect to prioritize the file correlation data. In this example, in the event that the printer access manager determines at operation 240 that a match is present between both 1) location correlation data and location information and 2) file correlation data and file data, the printer access manager can proceed to manage access according to the file correlation data, based on the user-selected priority. For example, in some embodiments, a user device can be in a first location, and location correlation data can associate the first location with “Printer A.” Continuing with this example, a user can open a first document on the user device, and file correlation data can associate the first document with “Printer B.” In this example, the printer access manager can determine that a match is present between both 1) location correlation data and location information and 2) file correlation data and file data. Further in this example, the printer access manager can inhibit access to all printers except “Printer B,” based on the user's election to prioritize the file correlation data.

The printer access manager can determine whether a match is present between: 1) location correlation data and location information and/or 2) file correlation data and file data. For example, in embodiments in which correlation data includes location correlation data, the printer access manager can determine that location information matches location correlation data in response to identifying that each includes the same location. For example, in some embodiments, the printer access manager can obtain location information indicating that a user device is located in a particular facility (e.g., “Austin Campus, Building 903”). Further in this example, the printer access manager can obtain location correlation data indicating that the user device associates “Printer 75-A” with “Austin Campus, Building 903.” Accordingly, the printer access manager can determine that the location information matches the location correlation data in response to identifying that each includes “Austin Campus, Building 903.”

In some embodiments, the printer access manager can determine that location information matches location correlation data in response to identifying that each includes a substantially similar location. For example, in some embodiments, the printer access manager can obtain location information indicating that a user device has a first set of GPS coordinates. Further in this example, the printer access manager can obtain location correlation data indicating that the user device associates a specific printer with a location having a second set of GPS coordinates. In response to identifying that the first set of GPS coordinates is within a threshold distance (e.g., 10-20 meters (m)) of the second set of GPS coordinates, the printer access manager can determine that the GPS coordinates are substantially similar. Accordingly, the printer access manager can determine that the location information matches the location correlation data. Conversely, the printer access manager can determine that the location information does not match the location correlation data in response to identifying that each does not include the same or a substantially similar location.

In another example, in embodiments in which correlation data includes file correlation data, the printer access manager can determine that file data matches the file correlation data in response to identifying that each includes the same information (e.g., file name, category designation, file type). For example, in some embodiments, the printer access manager can obtain file data indicating that the file “Org Chart.jpg” is opened on a user device. Further in this example, the printer access manager can obtain file correlation data indicating that the user device associates “Printer 3-C” with the file “Org Chart.jpg.” Accordingly, the printer access manager can determine that the file data matches the file correlation data in response to identifying that each includes “Org Chart.jpg.” Conversely, the printer access manager can determine that the file data does not match the file correlation data in response to identifying that each does not include the same information (e.g., file name, category designation, file type).

In response to the printer access manager determining a match is present between: 1) location correlation data and location information and/or 2) file correlation data and file data, the printer access manager can manage a user device's access to a set of printers according to the correlation data. In some embodiments, such managing can include the printer access manager inhibiting access to one or more printers by the user device. In some embodiments, such managing can include the printer access manager providing access to and displaying one or more printers by the user device. Inhibiting access to a printer by a user device can refer to the printer access manager restricting or obstructing the user device's ability to print a file to the printer. For example, in some embodiments, such inhibiting can include the printer access manager modifying visibility of the printer on a display of the user device. Such modifying can prevent or inhibit a user's ability to select the printer as a destination printer for printing a file. In some embodiments, modifying a visibility of the printer on a display of the user device can include changing a visual representation of the printer (e.g., a digital image, icon, name and/or symbol displayable to represent a printer on a graphical user interface). In some embodiments, changing the visual representation can include removing or hiding the visual representation. In some embodiments, changing the visual representation can include modifying an appearance of the visual representation, such as changing a color of the visual representation and/or displaying a symbol, such as an “X” or a strikethrough with the visual representation.

Conversely, allowing access to a printer by a user device can refer to the printer access manager removing a previously applied restriction or obstruction to the user device's ability to print a file to the printer. For example, in some embodiments, such allowing can include the printer access manager reversing a previous modification to a visibility of the printer on a display of the user device. For example, in some embodiments, such allowing can include making visible or unhiding a visual representation of the printer. In some embodiments, such allowing can include changing a color of a visual representation to an original or default color and/or removing a symbol, such as an “X” or a strikethrough previously displayed with the visual representation.

According to embodiments of the present disclosure, in an example based, in part, on Table 1 discussed above, a user can be traveling with a mobile phone having the location correlation data of Table 1. In this example, the user is in the Dallas office location at a first time. While in the Dallas office location, the user opens a document on the user device to print the document. Continuing with this example, based on network availability, a plurality of printers would be accessible by the user device for printing the document. Accordingly, based on such network availability, a set of visual representations corresponding to the plurality of printers would be displayed on the user device so that the user could select any of the plurality of printers for printing the document. However, based on the location correlation data, the printer access manager modifies the set of visual representations such that only the visual representation corresponding to the “Bldg. 3—Lobby” printer is visible on the user device for the user's selection to print the document.

Continuing with this example, the user travels to the Austin office location and is present in that location at a second time subsequent to the first time. While in the Austin office location, the user opens the document on the user device to print the document. Continuing with this example, based on network availability, a plurality of printers would be accessible by the user device for printing the document. However, in a manner similar to that discussed above, based on the new location and the location correlation data, the printer access manager modifies the set of visual representations such that a visual representation corresponding to “Printer 847-B” is allowed and made visible on the display of the user device. Furthermore, in this example, only the visual representation corresponding to “Printer 847-B” is visible on the user device for selection. Further in this example, the printer access manager inhibits access to alternate printers by displaying a prompt requesting that the user input a password in order to view and select such alternate printers.

Continuing with this example, the user forwards the document to a coworker at the Austin office location. When the coworker opens the document on the coworker's desktop computer, a printer access manager installed on the desktop computer manages access by the desktop computer to a set of printers according to correlation data stored on the desktop computer.

Continuing with this example, the user travels to the airport and is present at the airport at a third time subsequent to the second time. While in the airport, the user opens the document on the user device and inadvertently selects an icon on the graphical user interface of the user device for printing the document. In this example, in response to the airport location not being included in the location correlation data, the printer device manager can hide visibility of visual representations corresponding to all printers and permit visibility of an option to digitally print the document.

A display showing available printers can then be generated. This is illustrated at operation 219. When printer access filters have been applied at operation 240, the display can show printers selected based on the filter settings. However, if the printer access filter is not enabled (“no” at operations 210 and 216), a list of all printers identified by the user device may be displayed. In other embodiments, physical printer access may be inhibited when the filters are not enabled. An option allowing the user to return to printer access filter settings (e.g., at operation 213) may also be displayed. For example, operation 219 can include the printer access manager removing visual representations of all physical printers accessible by the user device and permitting a visual representation such as “print to PDF” to be displayed on the user device. In this way, the printer access manager can prevent inadvertent physical printing (e.g., printing a document to paper).

FIG. 3B is a schematic diagram illustrating example GUI elements 301 for displaying printing options, according to some embodiments of the present disclosure. In some embodiments, these elements 301 can be generated at operation 219 of process 200. A print options window 330 shows print options selected at operation 240, as well as an option for displaying other printers. In this example, a login window 339 can open in response to a user selecting option 335 (“display other printers”) from the printer window 330. A window 340 showing all available printers can be displayed upon correct entry of the login information. In other embodiments, window 340 can open in response to selection of option 335 without requiring a password. These and other options for display, security, etc. can be configured by an administrator, user, default settings, etc.

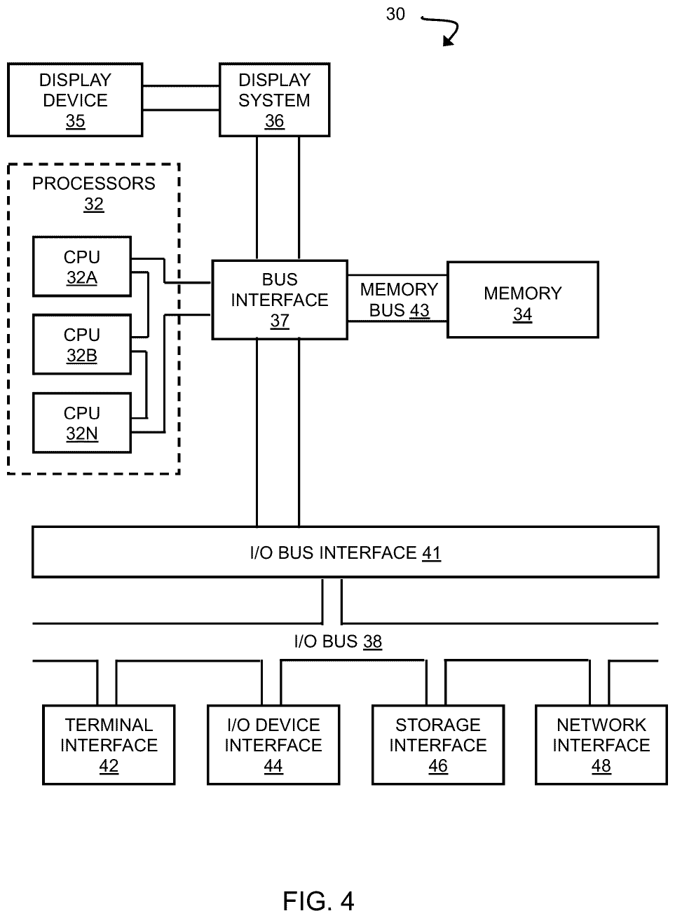

FIG. 4 is a block diagram illustrating an exemplary computer system 30 that can be used in implementing one or more of the methods, tools, components, and any related functions described herein (e.g., using one or more processor circuits or computer processors of the computer). In some embodiments, the major components of the computer system 30 comprise one or more processors 32, a memory subsystem 34, a terminal interface 42, a storage interface 46, an input/output device interface 44, and a network interface 48, all of which can be communicatively coupled, directly or indirectly, for inter-component communication via a memory bus 33, an input/output bus 38, bus interface unit 37, and an input/output bus interface unit 41.

The computer system 30 contains one or more general-purpose programmable central processing units (CPUs) 32A, 32B, and 32N, herein collectively referred to as CPU 32. In some embodiments, the computer system 30 contains multiple processors typical of a relatively large system; however, in other embodiments the computer system 30 can alternatively be a single CPU system. Each CPU 32 may execute instructions stored in the memory subsystem 34 and can include one or more levels of on-board cache.

The memory 34 can include a random-access semiconductor memory, storage device, or storage medium (either volatile or non-volatile) for storing or encoding data and programs. In some embodiments, the memory 34 represents the entire virtual memory of the computer system 30 and may also include the virtual memory of other computer systems coupled to the computer system 30 or connected via a network. The memory 34 is conceptually a single monolithic entity, but in other embodiments the memory 34 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory can be further distributed and associated with different CPUs or sets of CPUs, as is known in any of various so-called non-uniform memory access (NUMA) computer architectures.

Components of environment 100 (FIG. 1) can be included within the memory 34 in the computer system 30. However, in other embodiments, some or all of these components may be on different computer systems and may be accessed remotely, e.g., via a network. The computer system 30 may use virtual addressing mechanisms that allow the programs of the computer system 30 to behave as if they only have access to a large, single storage entity instead of access to multiple, smaller storage entities. Thus, components of the memory 34 are not necessarily all completely contained in the same storage device at the same time. Further, although components of environment 100 are illustrated as being separate entities, in other embodiments some of these components, portions of some of these components, or all of these components may be packaged together.

In an embodiment, components of environment 100 include instructions that execute on the processor 32 or instructions that are interpreted by instructions that execute on the processor 32 to carry out the functions as further described in this disclosure. In another embodiment, components of environment 100 are implemented in hardware via semiconductor devices, chips, logical gates, circuits, circuit cards, and/or other physical hardware devices in lieu of, or in addition to, a processor-based system. In another embodiment, components of environment 100 include data in addition to instructions.

Although the memory bus 33 is shown in FIG. 4 as a single bus structure providing a direct communication path among the CPUs 32, the memory subsystem 34, the display system 36, the bus interface 37, and the input/output bus interface 41, the memory bus 33 can, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the input/output bus interface 41 and the input/output bus 38 are shown as single respective units, the computer system 30 may, in some embodiments, contain multiple input/output bus interface units 41, multiple input/output buses 38, or both. Further, while multiple input/output interface units are shown, which separate the input/output bus 38 from various communications paths running to the various input/output devices, in other embodiments some or all of the input/output devices may be connected directly to one or more system input/output buses.

The computer system 30 may include a bus interface unit 37 to handle communications among the processor 32, the memory 34, a display system 36, and the input/output bus interface unit 41. The input/output bus interface unit 41 may be coupled with the input/output bus 38 for transferring data to and from the various input/output units. The input/output bus interface unit 41 communicates with multiple input/output interface units 42, 44, 46, and 48, which are also known as input/output processors (IOPs) or input/output adapters (IOAs), through the input/output bus 38. The display system 36 may include a display controller. The display controller may provide visual, audio, or both types of data to a display device 35. The display system 36 may be coupled with a display device 35, such as a standalone display screen, computer monitor, television, or a tablet or handheld device display. In alternate embodiments, one or more of the functions provided by the display system 36 may be on board a processor 32 integrated circuit. In addition, one or more of the functions provided by the bus interface unit 37 may be on board a processor 32 integrated circuit.

In some embodiments, the computer system 30 is a multi-user mainframe computer system, a single-user system, or a server computer or similar device that has little or no direct user interface but receives requests from other computer systems (clients). Further, in some embodiments, the computer system 30 is implemented as a desktop computer, portable computer, laptop or notebook computer, tablet computer, pocket computer, telephone, smart phone, network switches or routers, or any other appropriate type of electronic device.

It is noted that FIG. 4 is intended to depict the representative major components of an exemplary computer system 30. In some embodiments, however, individual components may have greater or lesser complexity than as represented in FIG. 4, Components other than or in addition to those shown in FIG. 4 may be present, and the number, type, and configuration of such components may vary.

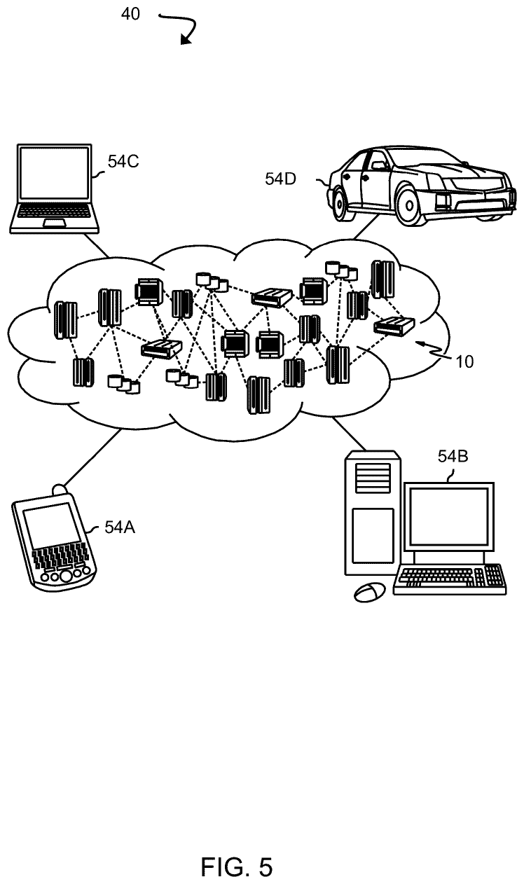

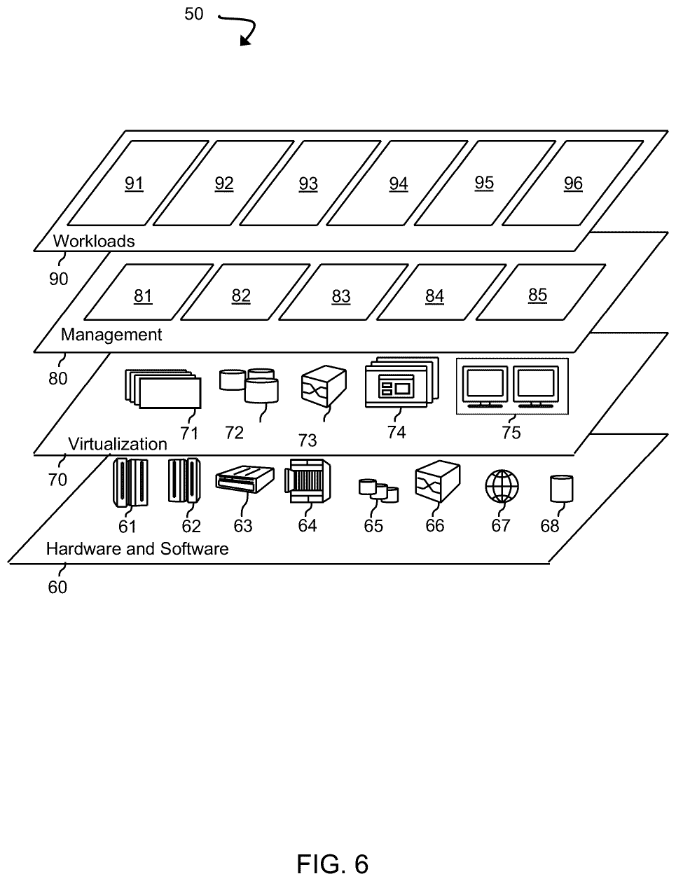

In some embodiments, the data storage and retrieval processes described herein could be implemented in a cloud computing environment, which is described below with respect to FIGS. 5 and 6. It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher-level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

FIG. 5 is a block diagram illustrating a cloud computing environment 40, according to some embodiments of the present disclosure. As shown, cloud computing environment 40 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54D may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 40 to offer infrastructure, platforms and/or software as services for which a cloud consumer does not need to maintain resources on a local computing device. It is understood that the types of computing devices 54A—54D shown in FIG. 5 are intended to be illustrative only and that computing nodes 10 and cloud computing environment 40 can communicate with any type of computerized device over any type of network and/or network addressable connection (e.g., using a web browser).

FIG. 6 is a block diagram illustrating a set of functional abstraction model layers 50 provided by the cloud computing environment 40, according to some embodiments of the present disclosure. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 provides the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment can be utilized. Examples of workloads and functions that can be provided from this layer include: mapping and navigation 91; software development and lifecycle management 92; virtual classroom education delivery 93; data analytics processing 94; transaction processing 95; and printer access management 96.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a standalone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the present disclosure.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof.

In the previous detailed description of example embodiments of the various embodiments, reference was made to the accompanying drawings (where like numbers represent like elements), which form a part hereof, and in which is shown by way of illustration specific example embodiments in which the various embodiments may be practiced. These embodiments were described in sufficient detail to enable those skilled in the art to practice the embodiments, but other embodiments may be used and logical, mechanical, electrical, and other changes may be made without departing from the scope of the various embodiments. In the previous description, numerous specific details were set forth to provide a thorough understanding the various embodiments. But, the various embodiments may be practiced without these specific details. In other instances, well-known circuits, structures, and techniques have not been shown in detail in order not to obscure embodiments.

When different reference numbers comprise a common number followed by differing letters (e.g., 100a, 100b, 100c) or punctuation followed by differing numbers (e.g., 100-1, 100-2, or 100.1, 100.2), use of the reference character only without the letter or following numbers (e.g., 100) may refer to the group of elements as a whole, any subset of the group, or an example specimen of the group.

As used herein, “a number of” when used with reference to items, means one or more items. For example, “a number of different types of networks” is one or more different types of networks.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, and item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; ten of item C; four of item B and seven of item C; or other suitable combinations.

1. A method, comprising:
receiving, at a printer access manager on a user device, a file to be printed, wherein the file is associated with file data designating a category of the file; and
in response to the receiving, managing printer access for the user device, wherein the managing comprises:
obtaining, by the printer access manager, printer location data from printers accessible to the user device;
identifying, by the printer access manager, a printer access filter enabled on the device;
filtering, by the printer access manager and in response to the identifying, the printers based on the category and the printer location data; and
inhibiting access to at least one of the printers based on the filtering.

2. The method of claim 1, wherein the printer access filter is enabled by a user in response to a security prompt.

3. The method of claim 1, further comprising generating a display of a set of the printers.

4. The method of claim 3, wherein the inhibiting access comprises omitting the at least one of the printers from the display.

5. The method of claim 1, wherein the managing the printer access is based on settings local to the user device.

6. (canceled)

7. (canceled)

8. A system, comprising:
a memory; and
a processor communicatively coupled to the memory, wherein the processor is configured to perform a method comprising:
receiving, at a printer access manager on a user device, a file to be printed, wherein the file is associated with file data designating a category of the file; and
in response to the receiving, managing printer access for the user device, wherein the managing comprises:
obtaining, by the printer access manager, printer location data from printers accessible to the user device;
identifying, by the printer access manager, a printer access filter enabled on the device;
filtering, by the printer access manager and in response to the identifying, the printers based on the category and the printer location data; and
inhibiting access to at least one of the printers based on the filtering.

9. The system of claim 8, wherein the printer access filter is enabled by a user in response to a security prompt.

10. The system of claim 8, further comprising generating a display of a set of the printers.

11. The system of claim 10, wherein the inhibiting access comprises omitting the at least one of the printers from the display.

12. The system of claim 8, wherein the managing the printer access is based on settings local to the user device.

13. (canceled)

14. (canceled)

15. A computer program product, the computer program product comprising a computer readable storage medium having program instructions embodied therewith, the program instructions executable by a processor to cause a device to perform a method, the method comprising:
receiving, at a printer access manager on a user device, a file to be printed, wherein the file is associated with file data designating a category of the file; and
in response to the receiving, managing printer access for the device, wherein the managing comprises:
obtaining, by the printer access manager, printer location data from printers accessible to the user device;
identifying, by the printer access manager, a printer access filter enabled on the device;
filtering, by the printer access manager and in response to the identifying, the printers based on the category and the printer location data; and
inhibiting access to at least one of the printers based on the filtering.

16. The computer program product of claim 15, wherein the printer access filter is enabled by a user in response to a security prompt.

17. The computer program product of claim 15, further comprising generating a display of a set of the printers.

18. The computer program product of claim 17, wherein the inhibiting access comprises omitting the at least one of the printers from the display.

19. The computer program product of claim 15, wherein the managing the printer access is based on settings local to the user device.

20. (canceled)

21. The method of claim 1, wherein the category describes content of the file.

22. The method of claim 1, wherein the category is a security category.

23. The method of claim 1, wherein two or more printer access filters are enabled on the device.

24. The method of claim 1, wherein the file data designating the category is input by a user.

25. The method of claim 1, wherein the file data designating the category is automatically configured.
